(19) United States
(12) Patent Application Publication
(10) Pub. No.: US 2012/0159646 A1
(43) Pub. Date: Jun. 21, 2012

(54) Storage device with a hidden space and its operation method

(75) Inventors: Yu Hong Chi, Kaohsiung City (CN); Chang Mao-Ting, Kaohsiung City (TW)

(73) Assignee: WALTON ADVANCED ENGINEERING INC., Kaohsiung (TW)

(21) Appl. No.: 12/929,514

(22) Filed: Jan. 31, 2011

(30) Foreign Application Priority Data
Dec. 16, 2010 (TW) 099144137

(51) Int. Cl. G06F 12/14; G06F 7/04

(52) U.S. Cl. 726/28

(57) ABSTRACT

A storage device with a hidden space comprises a case, a biometric identification device and a switch device and embodies digital data protected in a private zone without any concern about digital data disclosed to any person who holds a data disk according to a procedure of comparing a user's characteristic signals transferred from a user's features read by the biometric identification device with a test program in an automatic executive program.

### BACKGROUND OF THE INVENTION

1) FIELD OF THE INVENTION

The present invention relates to a data storage device, especially to a storage device with a hidden space, and its operation method.

2) DESCRIPTION OF THE PRIOR ART

Prosperous information and progressive technologies have embodied more and more digital data stored in various storage devices such as USB flash disk and mobile hard disk wherein the USB flash disk with advantages like handiness, portability, and plug-and-play is the most popular with the general public.

However, being short of a safety protection mechanism to conceal digital data, a conventional USB flash disk with a problem of digital data easily stolen may allow its digital data or even trade secrets to be exposed in case of the disk held by other people.

### SUMMARY OF THE INVENTION

To solve the said problem, the present invention is intended for providing a storage device with a hidden space and its operation method in which the invention comprises a case, a biometric identification device, and a switch device and delivers the purpose of protecting digital data in a private zone without any concern about digital data probably disclosed to another person holding the data disk by means of a procedure to compare a user's characteristic signals transferred from a user's features read by a biometric identification device with a test program in an automatic executive identification program.

To reach the said purpose, the present invention has the principal technical measures embodied with the following techniques. The present invention is one storage device provided with a hidden space and electrically connected to a computer and comprises a case, a biometric identification device and a switch device wherein the case has at least a memory unit, a control unit and a communications interface unit; the memory unit electrically connected to the control unit comprises a storage space used to store at least a digital data and accommodate at least a public zone and at least a private zone; the digital data has an automatic executive program used to perform management, comparison and verification; the control unit electrically connected between the memory unit and the communications interface unit is used to decide commands and control data imported or exported and comprises a virtual device module; the communications interface unit electrically connected to the control unit is used to couple with a port on the computer; the biometric identification device electrically connected to the control unit is used to receive a user's characteristic signals; the switch device is electrically connected to the control unit in which the virtual device module issues a request of linking a virtual device to the computer for the automatic executive program read by the computer when the switch device is set to “ON”.

The purposes and the technical issues with respect to the present invention are further embodied with the following technical measures.

In the said storage device with a hidden space, the public zone and the private zone in the storage space are freely accessed and used to store a user's general digital data.

In the said storage device with a hidden space, digital data saved in the storage space comprises any of a user's password, fingerprint, voiceprint, or iris or a combination of some features thereof.

In the said storage device with a hidden space, the automatic executive program comprises any of multiple programs for password verification, fingerprint verification, voiceprint verification, or iris verification (or a combination of some programs thereof), and a management module.

In the said storage device with a hidden space, the biometric identification device is any of devices to fetch fingerprint, voiceprint, or iris or a combination of some devices thereof.

In the said storage device with a hidden space, the virtual device module in the control element can be set to any virtual device with respect to CD-ROM, hard drive, or floppy disk.

In the said storage device with a hidden space, the communications interface unit is compatible to at least one of the following data transfer interfaces such as Universal Serial Bus (USB), Mini Universal Serial Bus (Mini USB), or Micro Universal Serial Bus (Micro USB).

The present invention is one storage device with a hidden space and has the operation steps as follows:
Step 1: The communications interface unit is coupled with a port on a computer;
Step 2: The switch device is set to “ON”;
Step 3: The virtual device module in the control unit issues a request of linking a virtual device to the computer for the automatic executive program automatically executed by the computer;
Step 4: Automatic verification by comparing a user's entered password or a user's characteristic signals received by the biometric identification device with a test program of the automatic executive program;
Step 5: A user is allowed to access, delete, or modify digital data in the private zone or add digital data into the private zone in the event of a comparison in Step 4 verified, or the user is allowed to access, delete, or modify digital data in the public zone or add digital data into the public zone.

Compared with the prior arts, the present invention is effective in a function of protecting digital data in the private zone and keeping it confidential without any concern about digital data probably disclosed to any person who holds the data disk.

### BRIEF DESCRIPTIONS OF THE DRAWINGS

FIG. 1 is the perspective view of the present invention of a storage device with a hidden space.

FIG. 2 is the sectional view of the present invention of a storage device with a hidden space.

FIG. 3 is the block diagram of the present invention of a storage device with a hidden space.

FIG. 4 is the flow diagram of the present invention of a storage device with a hidden space.

### DETAILED DESCRIPTIONS OF THE PREFERRED EMBODIMENTS

For objects, characteristics, and effects obviously and easily understood, the preferred embodiments of the present invention are particularly interpreted as follows:

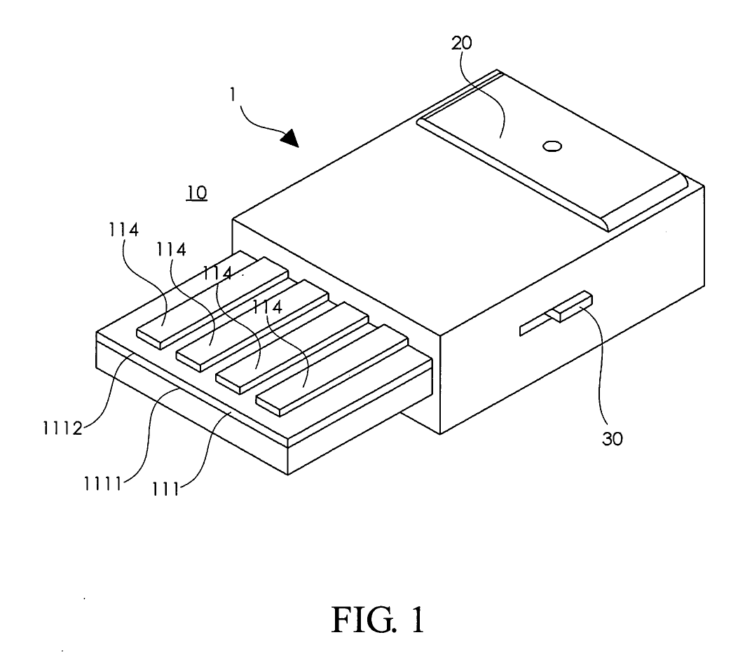

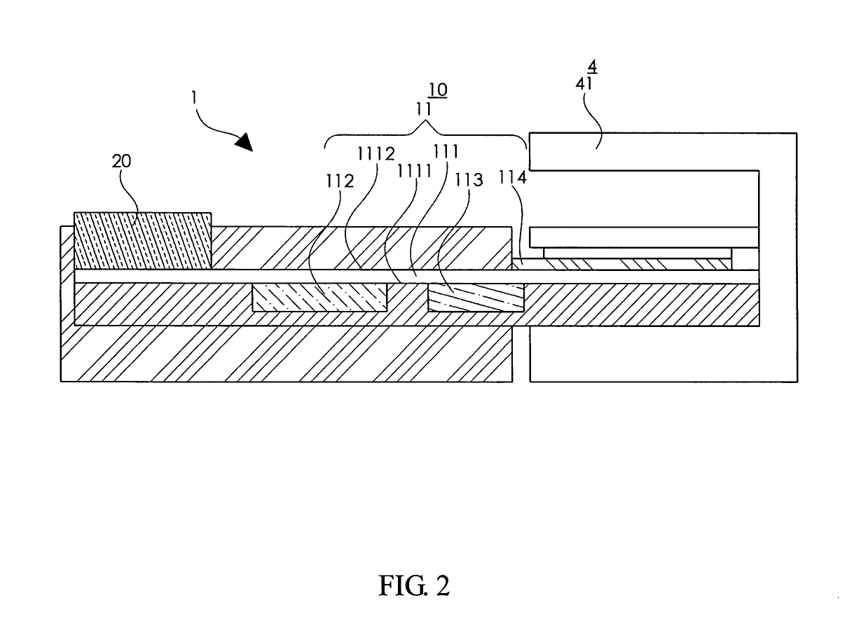

As shown from FIG. 1 to FIG. 4, the present invention is a storage device (1) with a hidden space and indicates a major embodiment with the device electrically connected to a computer (4). Referring to FIG. 1 and FIG. 2 in which there are a case (10), a biometric identification device (20) and a switch device (30). Preferably, the storage device (1) comprises but is not limited to a flash disk, a hard drive, or any data storage device with flash memories.

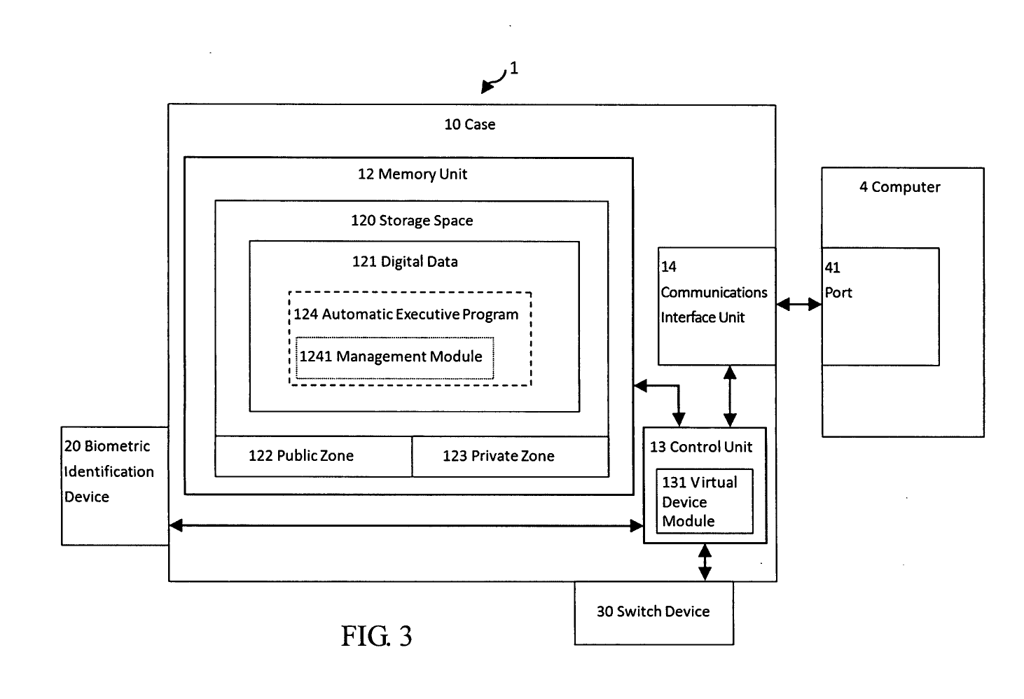

In the case of the switch device (30) set to “OFF”, a private zone (123) in the case (10) (FIG. 3) is hidden to protect a user's undisclosed data.

As shown in FIG. 2, the case (10) accommodates an integrated circuit module (11) encased with a Chip-On-Board (COB) package and comprising a substrate (111), at least a memory chip (112), at least a control element (113) and a plurality of metal contacts (114) wherein the memory chip (112) and the control element (113) are installed on an inner surface (1111) of the substrate (111), and a plurality of metal contacts (114) installed on an outer surface (1112) of the substrate (111) are used to link a port (41) of a computer (4).

Additionally, the substrate (111) is usually a high-density double-sided multi-layer printed circuit board with circuits (not shown in figures) developed inside as an interface for transmit of electricity and both the memory chip (112) and the control element (113) electrically connected to the metal contact (114).

The memory chip (112) and the control element (113) can be electrically connected to the substrate (111) with a wire bonding or a flip chip technique (not shown in figures).

The type of a memory chip can be FLASH memory, Static-Random-Access-Memory (SRAM), Application-Specific-Integrated-Circuit (ASIC), memory chip, or Synchronous-Dynamic-Random-Access-Memory (SDRAM).

Referring to FIG. 2 and FIG. 3 which indicate the memory chip (112) comprises at least a memory unit (12) and the control element (113) comprises a control unit (13) and a communications interface unit (14) wherein the memory unit (12) is electrically connected to the control unit (13), the memory unit (12) comprises a storage space (120) used to store at least a digital data (121), the storage space (120) comprises at least a public zone (122) (with a user's disclosed data saved) and at least a private zone (123) (with a user's undisclosed data saved) in which a user's general digital data is freely accessed.

In the case of the switch device (30) set to “OFF”, the private zone (123) is hidden to protect a user's undisclosed data.

Additionally, the digital data (121) comprises an automatic executive program (124) to perform management and comparison. To realize the purpose of enabling a private zone, the procedure automatically executed with the communications interface unit coupling to a port (41) on the computer (4) and the switch device set to “ON” is to compare a user's characteristic signals transferred from a user's features read by the biometric identification device (20) with a test program of the automatic executive program (124). Preferably, the test program of the automatic executive program (124) comprises but is not limited to any of multiple programs for password verification, fingerprint verification, voiceprint verification, or iris verification or a combination of these programs thereof.

Additionally, the digital data (121) also comprises but is not limited to a user's password, fingerprint, voiceprint, or iris or a combination of these data thereof to be verified. Furthermore, a management module (1241) in the automatic executive program (124) is effective in controlling these data with functions such as setup, addition, and deletion of these data and is preferably displayed to a user via an interface.

The control unit (13) electrically connected between the memory unit (12) and the communications interface unit (14) is used to decide commands and control data imported or exported and comprises a virtual device module (131). Preferably, the virtual device module (131) can be set to but not limited to any of virtual devices with respect to CD-ROM, hard drive, or floppy disk or a combination of these virtual devices thereof.

The communications interface unit (14) electrically connected to the control unit (13) is preferably compatible to at least one of the following data transfer interfaces such as Universal Serial Bus (USB), Mini Universal Serial Bus (Mini USB), or Micro Universal Serial Bus (Micro USB) and is electrically connected to a port (41) (USB port) of the computer (4) with the metal contacts (FIG. 2) (USB male connector (Series A) in this embodiment).

A biometric identification device (20) electrically connected to the control unit (13) is used to receive a user's characteristic signals. The biometric identification device (20) comprises but is not limited to any of these devices to fetch fingerprint, voiceprint, or iris or a combination of some devices thereof.

A switch device (30) electrically connected to the control unit (13) is used to enable or disable a private zone (123).

The next section is a detailed description of the present invention and its operation procedure for the storage device (1) with the case (10), the biometric identification device (20) and the switch device (30) integrated.

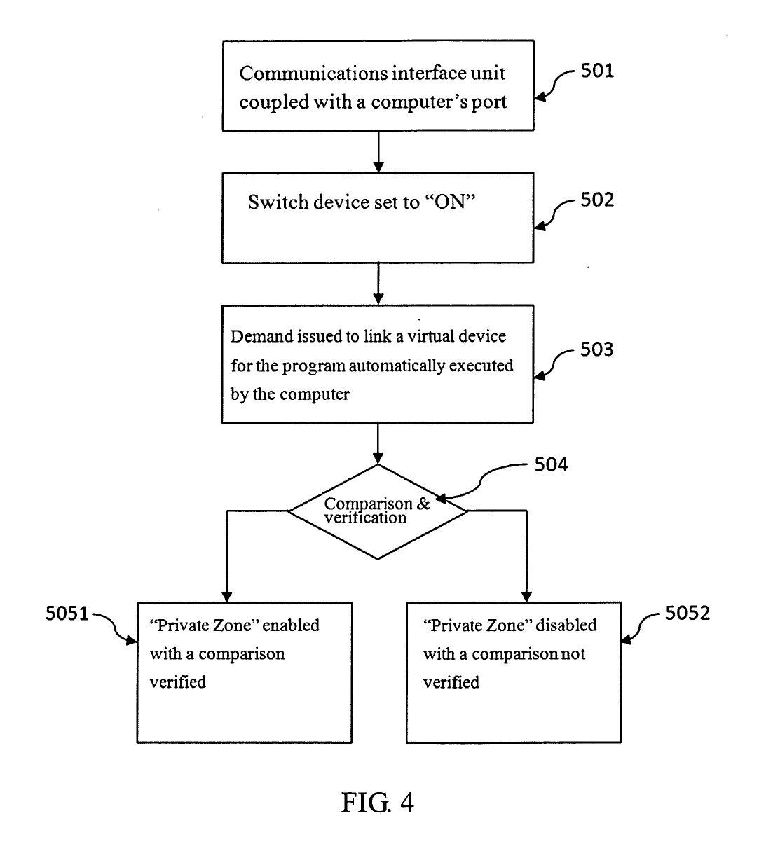

Referring to FIG. 3 and FIG. 4 which indicate the communications interface unit (14) is coupled to the port (41) of the computer (4) (501); the switch device (30) is set to “ON” (502) (Step 2); the virtual device module (131) of the control unit (13) issues a demand of linking a virtual device (a virtual CD-ROM in this embodiment) to the computer (4) which automatically reads the automatic executive program (124) (503) (Step 3); a user enters either a user's feature (for instance, fingerprint, voiceprint, or iris or a combination of these features thereof) in the biometric identification device (20) for generation of the user's characteristic signals to be verified or a password in the computer (4); next, the procedure is to compare and verify a user's entered password or a user's characteristic signals received by the biometric identification device (20) with a corresponding test program of the automatic executive program (comprising but not limited to a test program for password verification, fingerprint verification, voiceprint verification, or iris verification) (504) (Step 4); in the case of a comparison verified in Step 4, the private zone (123) is enabled to a user who can read, delete, or modify digital data saved in the private zone (123) or add data into the private zone (123) (5051); if not verified in Step 4, the private zone (123) is not enabled to a user who only read, delete, or modify digital data saved in the public zone (122) or add data into the public zone (122) (5052) (Step 5).

With the said descriptions summarized, the present invention comprising a case, a biometric identification device and a switch device and embodying a procedure to compare a user's characteristic signals transferred from a user's features read by the biometric identification device with a test program in the automatic executive program is effective in protecting digital data saved in a private zone without any concern about digital data disclosed to any person who holds this data disk. Accordingly, the present invention that is different from general conventional data storage devices but referred to as creative work among similar products meets patentability and is applied for the patent.

It must be stressed that the said descriptions are only the preferred embodiments of the present invention and any equivalent change in descriptions, claims, or drawings of the present invention is under protection of the technical scope of the present invention which accordingly depends on claims specified hereinafter.

What is claimed is:

1. A storage device (1) accommodating a hidden space and electrically connected to a computer (4), comprising:
A case (10) comprising at least a memory unit (12), a control unit (13) and a communications interface unit (14); where
The memory unit (12) electrically connected to the control unit (13) comprises a storage space (120) used to store at least a digital data (121) and accommodating at least a public zone (122) and at least a private zone (123); additionally, the digital data (121) has an automatic executive program (124) to perform management, comparison and verification;
The control unit (13) electrically connected between the memory unit (12) and the communications interface unit (14) is used to decide commands and control data imported or exported wherein the control unit (13) has a virtual device module (131);
The communications interface unit (14) electrically connected to the control unit (13) is used to couple with a port (41) of the computer (4);
A biometric identification device (20) electrically connected to the control unit (13) is used to receive a user's characteristic signals;
A switch device (30) electrically connected to the control unit (13) is used to enable or disable the private zone (123) and the virtual device module (121) of the control unit (12) issues a demand of linking a virtual device to the computer (4) for the automatic executive program (124) automatically read by the computer (4) when the switch device (30) is set to “ON”.

2. The storage device with a hidden space according to claim 1 wherein the public zone (122) and the private zone (123) in the storage space (120) are freely accessed and used to store a user's general digital data.

3. The storage device with a hidden space according to Claim wherein the digital data (121) saved in the storage space (120) comprises a user's password, fingerprint, voiceprint, or iris or a combination of some features thereof.

4. The storage device with a hidden space according to claim 1 wherein the automatic executive program (124) comprises any of programs for password verification, fingerprint verification, voiceprint verification, or iris verification (or a combination of some programs thereof) and a management module (1241).

5. The storage device with a hidden space according to claim 1 wherein the biometric identification device (20) can be any of devices to fetch fingerprint, voiceprint, or iris or a combination of some devices thereof.

6. The storage device with a hidden space according to claim 1 wherein the virtual device module (131) in the control element (13) can be set to any virtual device with respect to CD-ROM, hard drive, or floppy disk.

7. The storage device with a hidden space according to claim 1 wherein the communications interface unit (14) is compatible to at least one of the following data transfer interfaces such as Universal Serial Bus (USB), Mini Universal Serial Bus (Mini USB), or Micro Universal Serial Bus (Micro USB).

8. An operation method of the storage device with a hidden space has the following steps:
Step 1: The communications interface unit is coupled with a computer's port;
Step 2: The switch device is set to “ON”;
Step 3: The virtual device module in the control unit issues a request of linking a virtual device to the computer for the automatic executive program automatically executed by the computer;
Step 4: Automatic verification by comparing a user's entered password or a user's characteristic signals received by the biometric identification device with a test program in the automatic executive program;
Step 5: A user is allowed to access, delete, or modify digital data in the private zone or add digital data into the private zone in the event of a comparison in Step 4 verified, or the user is allowed to access, delete, or modify digital data in the public zone or add digital data into the public zone.
